(19) United States
(12) Patent Application Publication
(10) Pub. No.: US 2024/0207990 A1
(43) Pub. Date: Jun. 27, 2024

(54) Rack magazine with setup unit

(71) Applicant: Gebr. Heller Maschinenfabrik GmbH, Nürtingen (DE)

(72) Inventors: Jochen Kern, Gomaringen (DE); Lars Kant, Leonberg (DE); Thomas Haussmann, Oberboihingen (DE); Jan Langer, Aichtal (DE)

(21) Appl. No.: 18/394,335

(22) Filed: Dec. 22, 2023

(30) Foreign Application Priority Data
Dec. 22, 2022 (DE) 10 2022 134 568.8

(51) Int. Cl. B23Q 3/155

(52) U.S. Cl. CPC B23Q 3/15526

(57) ABSTRACT

A tool rack magazine for a machine tool for chip removal machining of workpieces, particularly workpieces consisting of metal. The rack magazine includes a tool holding device including a setup unit. The setup unit can be moved into and out of a storage space of tool holding device. Along the tool holding device including setup unit a loader passage with a movable loader is provided. Because a separation device is provided between setup unit and storage space, the machine tool can be operated independent from the position of the setup unit. In doing so, a main time concurrent setup is made possible.

### CROSS REFERENCE TO RELATED APPLICATIONS

This application claims priority under 35 U.S.C. $119 to the following German Patent Application No. 10 2022 134 568.8, filed on Dec. 22, 2022, the entire contents of which are incorporated herein by reference thereto.

### TECHNICAL FIELD

The present disclosure refers to a tool magazine in form of a rack magazine with setup unit. The rack magazine is provided for a machine tool, particularly a machine tool for chip removing machining of workpieces, particularly in the field of metal machining.

### BACKGROUND

Machine tools are frequently linked with tool magazines in which tools are provided in larger numbers. The different tools are thereby typically provided in tool holders with standardized interface in order to be able to be inserted and removed automatically during the progress of workpiece machining. The machine tool allows an automatic machining of workpieces in cooperation with the tool magazine and a tool changer.

EP 2 251 138 B1 discloses a tool magazine having a tool holding device and a loader assigned thereto. The loader serves to transfer the tools from their storage position in the magazine in a takeover position in which a common two-forked tool changer having a horizontal rotation axis takes over the tool in order to transfer it to a tool spindle of the machine tool or therefrom to the loader. Thereby the loader is configured to carry out a horizontally orientated movement in X-direction transverse to the rotation axis of the tool changer and in addition, a movement in the vertical Y-direction. In addition, the loader comprises a telescopic drive to move the tool in a horizontal Z-direction orientated orthogonal to the two directions mentioned above. The tools are orientated with their center axes also in the Z-direction orientated parallel to the rotation direction of the tool changer.

A machine tool linked with a tool magazine and having a work spindle that can be transferred in vertical direction is known from EP 3 061 562 B1. Here the tool changer comprises a vertical rotation axis. The tool magazine stores all tools in a hanging manner with vertical center axis. For transfer of tools from the magazine into the tool changer and back, a two-axis loader is provided. The latter comprises a slide that can be moved in vertical direction Y and longitudinal direction Z. The slide supports a pivot arm that can be pivoted around the vertical axis and comprises a receptacle for tool holders at its free end.

DE 10 2011 088 055 A1 also discloses a machine tool linked with a tool magazine. The tool magazine comprises a tool rack with tools arranged in a lying manner and in addition with tools orientated in a hanging manner. A tool carousel having a horizontal rotation axis is assigned to the tool rack, wherein a loader is configured to transfer the tools from the tool rack into the tool carousel and back. For handover of tools between the tool carousel and the machine tool a common tool changer having two holding forks is provided.

A tool magazine has to be frequently set up again, i.e. tools have to be removed from the tool magazine or have to be supplied thereto. The reason for this is, for example, a change of the workpiece type to be machined, for which in most cases tools of different type are required. The tools of the tool magazine also require service from time to time. Worn tools have to be replaced, refurbished or repaired. In addition, tools have to be adjusted frequently. This comprises, for example, the measurement and/or adjustment of the position of the tool in the assigned tool holder.

For setup of tools of the tool magazine, access to the tools is necessary. For this purpose, however, the tool automization that can comprise all moveable parts of the tool magazine, such as a loader or other tool transport devices, have to be stopped from moving. This can hinder the operation of the machine tool remarkably and can interrupt the operation of the machine tool for a longer period.

### BRIEF SUMMARY

It is the object of the present disclosure to provide a concept by means of which the tool magazine can be set up, whereby nevertheless an uninterrupted operation of the machine tool shall be made possible.

A tool rack magazine for a machine tool for chip removing machining of metal workpieces, including: a tool holding device configured for holding tools, at least one setup unit that can be moved into and out of a storage space in the tool holding device, a loader that can be moved in a second direction inside a loader passage, which is orientated transverse to a first direction, wherein the loader passage extends along the tool holding device including the setup unit, wherein a separation device is provided between the loader passage and the storage space.

The tool rack magazine according to the present disclosure comprises a first, preferably stationary, i.e. immovable, tool holding device in which the tools are preferably orientated in a lying manner in a first direction X. The first direction X is preferably orientated transverse to a horizontal work spindle of a machine tool that is to be arranged next to the tool rack magazine and thus also transverse to a rotation axis of a usual tool changer. The tools orientated in a lying manner can be slightly inclined relative to the horizontal or also substantially exactly horizontally orientated. Preferably, the tips of the tools face away from a loader passage in which a loader can move in horizontal direction and, if appropriate, also in vertical direction between the tool holding device and a machine tool.

In addition, the tool rack magazine comprises a mobile setup unit, which can be inserted into a storage space provided in the tool holding device and which can be moved out of the storage space and can be moved away from the rack magazine. If the setup unit is separated from the rack magazine, it can be moved into an indeterminate position along an indeterminate path. If the setup unit is arranged inside the storage space, the tools are preferably held in corresponding orientation compared with the tools of the remaining tool holding device.

A separation device is provided between the loader passage and the storage space. In a first condition the separation device locks the passage between the storage space and the loader passage mechanically and thus avoids the access of persons to the loader passage in case the setup unit is not located in the storage space. In addition, the separation device is configured to block ejection of chips or fragments through the storage space outwardly as long as the separation device is closed.

With this concept it is possible to provide tools in the setup unit, which have to be inserted into the rack magazine. One or more setup units can be set up with tools in a preliminary manner, can be provided and then inserted into the storage space of the rack magazine as required. After complete opening of the separation device, the tools of the setup unit are then accessible for the loader and can either be directly transferred to the machine tool or else can be sorted and resorted into the remaining rack magazine. Similarly, also used tools can be transferred from the machine tool or the rack magazine into the setup unit. After complete closing of the separation device, the setup unit can be removed from the rack magazine and can be guided to a setup location. An operation interruption of the machine tool is not necessary for this purpose.

A blocking device can be provided that allows to bring the setup unit out of the storage space only after a complete closing of the separation device. Thereby the blocking device can be arranged in an interstice between the storage space and the loader passage. Alternatively, the blocking device can also be arranged inside the storage space. In this case, it can close only when the setup unit is at least partly brought out of the storage space. In this case, it is expedient, if the blocking device including its control is configured to block the full movement of the setup unit out of the storage space, at least as long as the blocking device is not completely closed.

The tool holding device comprises a first tool holder receptacle means adapted to the tool holder. Such tool holder receptacle means are preferably also provided on the setup unit. The loader can then serve the setup unit when the separation device is open as well as the otherwise tool holding device.

It is advantageous, if the tool holding device is configured to receive and store the tools in rows one above the other, if removal passages are provided between the rows. Preferably the removal passages comprise a width that is slightly longer than the longest considerable diameter of a tool, so that the tools can be transferred in a combined linear and pivot movement out of the tool holding device into the loader passage. The loader pivots the tools thereby around approximately 90° from their X-orientation into Z-orientation. This concept turns out to be space-saving and efficient.

Preferably the first tool holder receptacle means of the tool holding device are arranged in a first plane and second tool holder receptacle means of the setup unit are arranged in a second plane, wherein the first and second plane are positioned with distance to one another so that an interstice is defined therebetween.

The two planes can be orientated parallel to one another. In doing so, the separation device can be arranged in this interstice so that it does not limit the space of the loader passage. The advantage of this concept is that the separation device can be opened and closed while the setup unit is still arranged in its desired position inside the storage space. Situations in which the separation device closes only when the setup unit has already left the storage space or is at least partly brought out of the latter can be avoided. On the other hand, it is also possible to configure the separation device so that it can only close after the setup unit has at least partly moved out of the storage space. An intermediate blocking can be thereby provided and configured to block a complete movement of the setup unit out of the storage space as long as the separation device has not fully closed. Also in this manner, safety against manual access to the loader passage and against the ejection of chips or fragments through the open storage space can be created. The advantage of this solution is that the tools held by the setup unit are not subject to other limitations regarding their length compared with the tools in the other tool holding device. In addition, all tool holder receptacle means can be arranged in one and the same plane.

The separation device comprises a closure element connected with a drive device in order to open and close the closure element. For example, the closure element can be a blind, particularly a blind consisting of metal slats.

The drive device can be connected to a control that controls the operation of the rack magazine. Other than the separation device the control can particularly also control the operation of the loader and can be additionally connected with the control of a machine tool that is to be served.

Thereby the control can control the loader in different operation modes. If the closure element is open and the setup unit is not in the storage space, it can operate the loader and, if necessary, also provide a signal to the machine tool in order to transfer it or them into a safe operating condition, e.g. hault. If the closure element is in the open position and the setup unit is inside the storage space, the control can allow the unlimited operation of the loader. The latter has thus access to the tools in the setup unit as well as to the other tools, so that the operation of the machine tool is possible without limitations. In addition, the loader can resort tools in the rack magazine while the machine tool operates, e.g. resort tools from the second into the first tool holder receptacle means or from the first tool holder receptacle means into the second tool holder receptacle means.

If the closure element is closed, the control can further operate the loader without limitations in thus far that it can carry out any tool change from the first tool holder receptacle means in the machine tool and from the machine tool into the first tool holder receptacle means. In addition, in this situation as with an open separation device the loader is able to serve a complement magazine, which can be potentially provided on the face side in which the tools have been provided, e.g. horizontally orientated in Z-direction.

### BRIEF DESCRIPTION OF THE DRAWINGS

Details of advantageous embodiments are derived from the drawing, the associated description or from dependent claims, wherein the drawing shows:

FIG. 1 a machine tool with rack magazine in schematic perspective illustration,

FIG. 2 the rack magazine and the machine tool according to FIG. 1 in schematic sectional top view,

FIG. 3 the rack magazine in a perspective simplified backside view,

FIG. 4 a schematic sectional top view onto the rack magazine and its setup unit for illustration of spatial structure principles,

FIG. 5 a block diagram for illustration of the control concept of the rack magazine,

FIG. 6 the loader provided in the rack magazine in schematic spatial illustration,

FIGS. 7 to 9 the rack magazine in top view in different operating stages.

### DETAILED DESCRIPTION

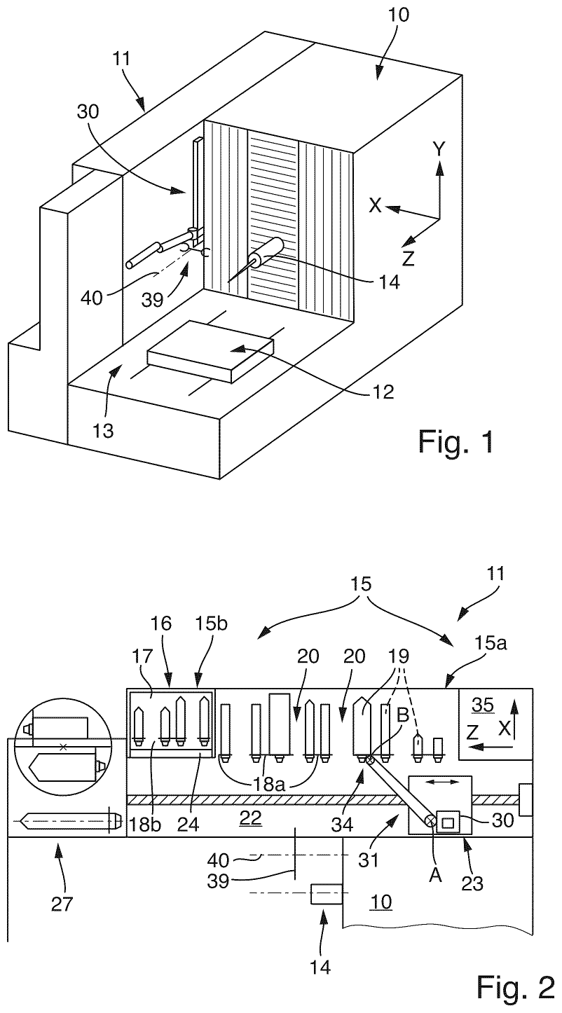

In FIG. 1 a rack magazine 11 linked with a machine tool 10 is illustrated, which is arranged at a flank of the machine tool. The machine tool comprises an immovably or movably arranged workpiece holder 12 arranged in a work space 13 of the machine tool 10. In the work space 13 also at least one work spindle 14 is arranged, which comprises a non-illustrated receptacle for a tool or a tool holder as well as a rotation drive. The rotation axis of the work spindle 14 is arranged orthogonal to a first horizontal direction, the X-direction, as well as orthogonal to a vertical direction, the Y-direction. The rotation axis preferably corresponds to a horizontal Z-direction arranged orthogonal to the X-direction and the Y-direction. If required, the work spindle 14 can be arranged in a pivotable or inclinable manner as well as movable in X- and Y-direction. For example, workpiece holder 12 can be movable in Z-direction and, for example, in another direction and can be arranged rotatably or pivotably. The flank of the machine tool extends in X- and Y-direction.

The rack magazine 11 is placed laterally in X-direction next to the machine tool 10 and preferably extends along the entire length of the machine tool 10 to be measured in Z-direction or at least a remarkable portion of the length, as schematically illustrated in FIG. 2. In addition, the tool magazine 11 extends along the entire height of the machine tool 10 to be measured in Y-direction or at least a remarkable portion of the height.

Alternatively, the rack magazine 11 can also extend beyond machine tool 10 in Y-direction and/or Z-direction.

The rack magazine 11 comprises a tool holding device 15, which has an immovable section 15a and at least one movable section 15b being part of a setup unit 16.

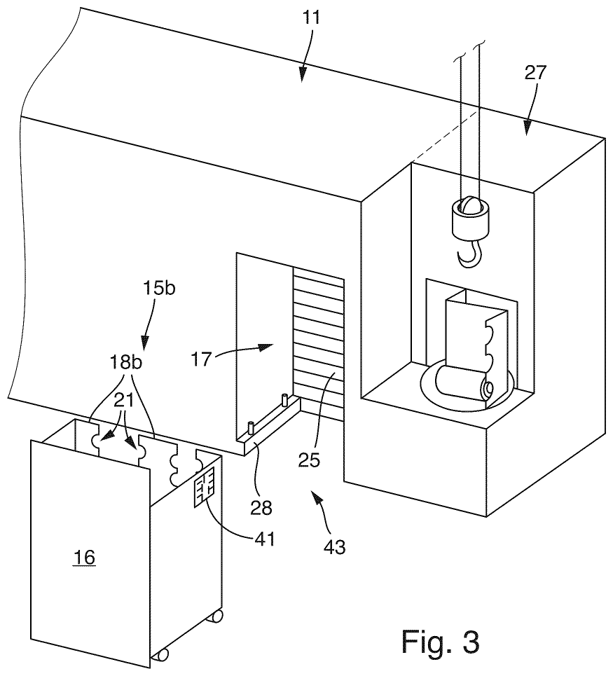

The tool holding device 15 or the rack magazine 11 comprises a storage space 17 (see also FIG. 3) into which the setup unit 16 can be moved and from which the setup unit 16 can be taken out. In FIG. 2 the setup unit is illustrated in its position inside the storage space 17.

The tool holding device 15 comprises in its first section 15a immovably arranged first tool holder receptacle means 18a. For example, the latter can be configured as vertical walls with lateral muzzle-type cutouts into which the tool holder with the tools 19 can be inserted. The tools 19 are thereby arranged in a lying manner and face with their tips away from the machine tool 10. Removal passages 20 can be provided between the tools 19 via which the individual tools 19 can be moved out of the tool holder receptacle means 18a.

In the second section 15b of the tool holding device 15, i.e. within the setup unit 16, second tool holder receptacle means 18b are arranged in which tools 19 can be arranged as well. Thereby FIG. 3 illustrates by way of example the configuration of the second tool holder receptacle means 18b with muzzle-type openings 21 into which tools 19 can be hung up in horizontal orientation. The cutouts 21 of adjacent walls are preferably arranged facing one another and with slightly increasing opening direction in the first section 15a as well as in the second section 15b. They serve for holding tool holders in which tools 19 are held. The tool holders can comprise arbitrary standardized connection devices for the work spindle 14, e.g. hollow shank tapers, steep tapers or the like. Due to the orientation and the configuration of the walls, the tool holding device 15 is configured for holding tools 19 in horizontal orientation. The tools 19 of the entire tool holding device 15 are orientated with their rotation or center axes in X-direction and thus orthogonal to the rotation axis of the work spindle 14.

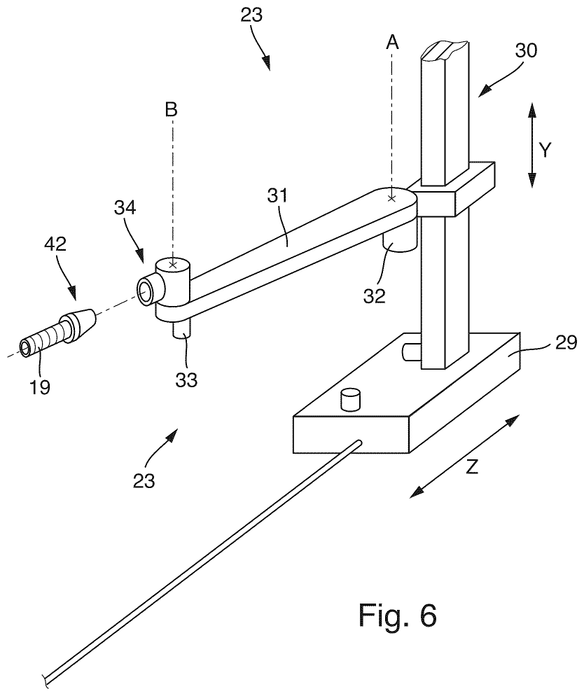

For transport of tools 19 within the rack magazine 11 or also for transfer to the machine tool 10, a loader passage 22 is provided in which a loader 23 is movably arranged that is individually illustrated in FIG. 6. The loader passage 22 extends thereby along the entire length of the rack magazine 11 so that the loader can reach and handle tools 19 of section 15a as well as tools 19 in the setup unit 16 arranged in section 15b.

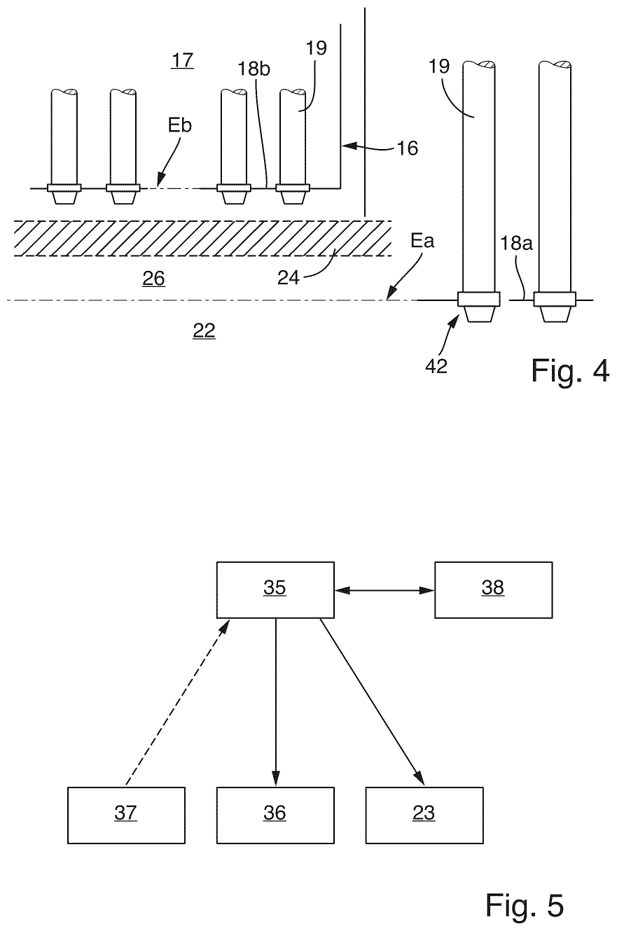

Between the storage space 17 with the setup unit 16 and the loader passage 22 a separation device 24 is arranged, which is illustrated in FIGS. 2 and 4 in symbolic manner. The separation device 24 comprises a separation element 25, e.g. in form of a blind, a slider or another movable means, which can close and open the storage space 17 relative to the loader passage 22.

As illustrated in FIG. 4, first tool holder receptacle means 18a and second tool holder receptacle means 18b are preferably arranged in two different planes Ea and Eb, so that an interstice 26 is formed between these two preferably parallel planes Ea, Eb. The separation device 24 and particularly the separation element 25 are preferably arranged inside this interstice so that the loader can move inside the entire loader passage 22 and can also reach and transport tools of a complement magazine 27 when the separation element 25 is open as well as when the separation element 25 is closed. A complement magazine 27 can be arranged at an end of loader passage 22 and can be installed upstream in Z-direction. In the complement magazine 27 the tools are preferably held facing horizontally in Z-direction.

The setup unit 16 illustrated in FIG. 3 can be configured as carriage, for example, the contour of which corresponds to the storage space 17 so that it closes the latter completely outwardly, if it is moved into the storage space 17. As an alternative to a carriage, the setup unit 16 can also be configured as frame having feet, which can be moved into or moved out of the storage space 17 by means of suitable handling devices such as pellet trucks, forklift trucks, automated guided vehicles (AGV) or the like.

For accurate positioning of the setup unit 16 inside storage space 17, holding or support means 43 can be provided, particularly holding or support means 43 with positioning devices. For example, in the bottom area of storage space 17 support bars 28 can be arranged as holding and support means 43, which are immovable or which are adjustable in height direction in order to engage the setup unit 16 from below. Form-fit means such as bolts or the like can be immovably or extendably arranged in the support bar 28 in order to facilitate a desired positioning of the setup unit 16. Alternatively or additionally, additional mechanical alignment means can be provided. Alternatively or additionally, the storage space 17 or the loader passage 22 or the loader 23 can be provided with one or more cameras in order to detect the position of tools 19 or their tool holders 42 or alternatively the position of the setup unit 16 and to facilitate a specific gripping by the loader.

Preferably at least one position mark 41 is arranged on the setup unit 16 (see FIG. 3). The position mark 41 can be a QR-code, for example. The position mark 41 can be captured by one or more cameras after the setup unit 16 has been positioned inside the storage space 17. From the camera-based position recognition, the advantage results that no exact positioning of the setup unit 16 inside the storage space is required. Due to the camera-based position recognition, the actual position of the setup unit 16 relative to a desired position inside the storage space 17 is determined and transmitted to a control 35 (see FIG. 5). The control 35 is preferably configured to detect deviations of the setup unit 16 from a desired position and to move the loader 23 to respectively corrected positions of tool holders inside setup unit 16.

The position marks 41 can contain additional information besides the position information. For example, they can individualize the respective setup unit when multiple setup units 16 are used or can also comprise other information, e.g. about the tools.

The determination of the actual position of the setup unit 16 can comprise position deviations in X-direction and/or Y-direction and/or Z-direction as well as angular deviations around an A-axis and/or a B-axis and/or a C-axis. In doing so, the spatial position of the setup unit 16 can be determined very precisely. Particularly advantageous is the arrangement of two or more position marks on the setup unit 16, particularly preferably with large distance to one another. Thereby, position deviations can be determined, particularly accurately and a reliable gripping of tool holders 42 by means of the loader 23 is made possible. In a specific embodiment two or more position marks 41 can be arranged on respectively different sides of setup unit 16. A position deviation can then be determined with very high accuracy by means of multiple cameras that are respectively aligned on a specific side of the setup unit 16.

As an alternative to the use of position marks 41 on setup unit 16, the position of each individual tool inside setup unit 16 can be directly determined by one or more cameras. It is particularly advantageous in this embodiment, if the camera is arranged on the loader 23. The loader 23 can move the camera at least in proximity to a respective desired position of a tool holder 42 and determine its actual position there. The control 35 is configured to consider deviations of each individual tool holder 42 from a desired position and to guide the loader 23 to respectively corrected positions of the tool holders 42 inside setup unit 16.

Alternatively to a camera, other sensors can be provided for determination of orientation and position. For example, tactile sensors for probing of position marks 41 on setup unit 16 can be provided. In such an embodiment the tactile sensor is preferably arranged on the loader 23. The control 35 is then configured to use the movement axis of loader 23 in X-direction, Y-direction and Z-direction in order to probe the multiple position marks on setup unit 16. The probing in X-direction, Y-direction and Z-direction can be carried out in a simple manner by means of linear movements or pivot movements of the loader—if required in combination of the two movements. The position marks are preferably configured as precision spheres in case of a tactile probing. Also when using tactile sensors, the position of each individual tool inside setup unit 16 can be determined thereby. The control 35 can be configured to move the tactile sensor by means of loader 23 into the area of a respective tool holder 42 and to probe the latter.

The loader 23 is preferably configured according to the basic illustration shown in FIG. 6. It comprises a slide 29, which is horizontally movable in Z-direction and which is provided with a vertical guide 30. On the latter an arm 31 is pivotably supported around a vertical axis A. The pivot axis A is preferably orientated in Y-direction. In order to facilitate the controlled pivot movement, a pivot drive 32 is provided.

On the end of arm 31 located away from vertical guide 30 an additional pivot drive 33 is arranged by means of which a gripper 34 can be pivoted around an axis B being parallel to axis A. The gripper 34 is configured to grip a tool holder 42.

The operation of the rack magazine 11 is controlled by means of control 35, which is schematically illustrated in FIG. 5. It thereby controls the movements of loader 23 as well as a drive device 36 of separation element 25. In addition, the control 35 can receive signals from sensors 37, if necessary, that can be provided, for example for detection of the position of the separation element 25 and/or the detection of the position of the setup unit 16. For example, it can be at least detected whether separation element 25 is opened or closed and/or whether the setup unit 16 is located inside storage space 17 or not. In addition, at least as an option, sensors 37 can be provided in order to detect the position of gripper 34 or other elements of loader 23. Also the sensors 37 can comprise one or more cameras, e.g. in order to detect the spatial position of the tool holders 42 of tools 19 inside setup unit 16 with sufficient accuracy.

If required, control 35 can be connected to a machine control 38, which is part of the machine tool 10.

The rack magazine 11 described so far operates in cooperation with machine tool 10 as follows:

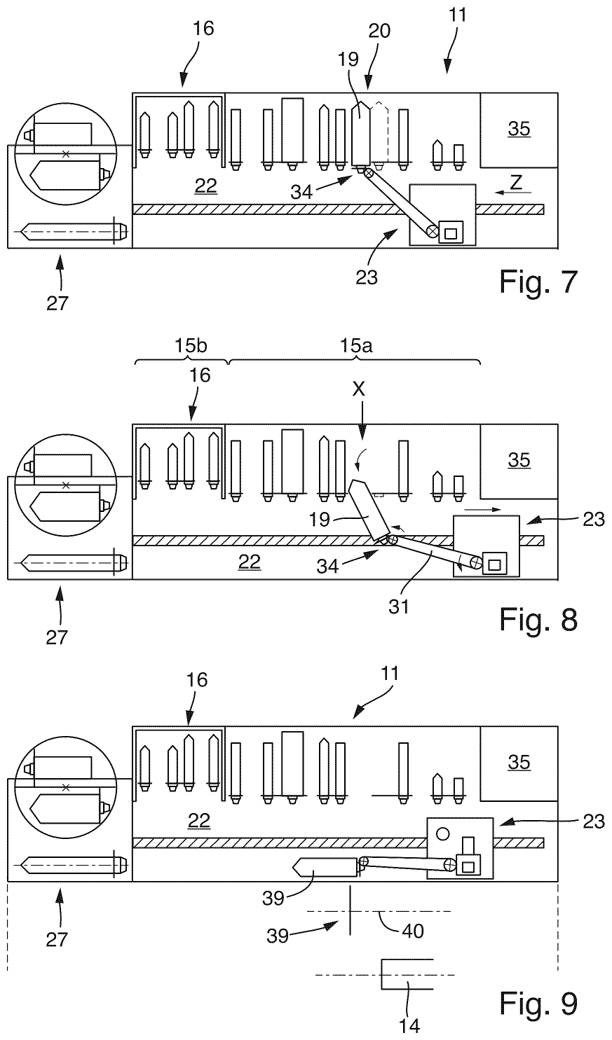

The tools 19 can be removed from their rack positions according to the scheme of FIGS. 7-9 and can be transferred back into these positions again. As apparent, loader 23 grips the tool holder of tool 19 by means of its gripper 34 and first moves the tool according to FIG. 7 from its storage position into the removal passage 20. According to FIGS. 8 and 9, tool 19 is then transferred out of removal passage 20 into loader passage 22 by means of a movement in X-direction in combination with a pivot movement. Thereby loader 23 carries out a drive movement while its arm 31 pivots. FIG. 8 illustrates tool 19 then being orientated in Z-direction from which orientation it can be transferred into the machine spindle 14 by means of a tool changer 39, which is only schematically indicated in FIGS. 2 and 9. The tool changer 39 can be a common two-forked changer, which is pivotable around a tool changer axis 40 orientated parallel to the rotation axis of tool spindle 14 and which is also movable in Z-direction in order to move tool 19 into work spindle 14 or out of the latter.

The tool changer 39 can thereby reach tools, exchange them among each other and/or move them into or out of work spindle 14, whereby the tools are tools of setup unit 16 as well as the remaining tools. The setup unit 16 insofar a full-featured component of rack magazine 11.

The insofar unlimited operation of loader 23 is allowed by control 35, if two requirements are fulfilled, namely: a) The closure element 25 is completely open and b) the setup unit 16 is positioned in a correct position inside storage space 17. For detection of this condition (as well as deviating conditions), suitable sensors can be provided connected to control 35.

For set up of tools, the setup unit 16 can be removed from rack magazine 11. For this purpose, control 35 commands closing of closure element in that it controls the drive device 36 accordingly. Concurrently control 35 limits the operation possibility of loader 23 without stopping it completely. Rather it can continue to serve all tool holder receptacle means 18 of section 15a as well as, if applicable, also the tool storage locations of complement magazine 27. However, control 35 is configured to block in this situation the access of loader 23 to tool holder receptacle means 18b of second section 15b. Thereby, machine tool 10 can continue to operate nearly entirely in unlimited manner. Further, the exchange of tools between work spindle 14 of machine tool 10 and section 15a of tool holding device 15 as well as work spindle 14 of machine tool 10 and complement magazine 27 is possible.

If and as long as the separation device 24 is open without a setup unit 16 being located in the storage space 17, for example resulting from a disturbance or from other influences, control 35 blocks the operation of rack magazine 11. In addition, control 35 can be configured to send a signal to the control of the machine tool. The machine tool 10 can be configured to transition into a safe operation, e.g. hault, upon receipt of such a signal.

The tool rack magazine 11 according to the present disclosure is provided for a machine tool 10 for chip removal machining of workpieces, particularly workpieces consisting of metal. The rack magazine 11 comprises a tool holding device 15 comprising a setup unit 16. The latter can be moved into and out of a storage space 17 of tool holding device 15. Along the tool holding device including setup unit 16 a loader passage 22 with a movable loader 23 is provided. Because a separation device 24 is provided between setup unit 16 and storage space 17, the machine tool 10 can be operated independent from the position of the setup unit 16. In doing so, a main time concurrent setup is made possible. The term “main time concurrent setup” refers to the setup of tools in a tool magazine and firstly means setup during machining of a workpiece by means of the work spindle and secondly means setup during a movement of loader 23 inside loader passage 22. The machining of a workpiece and the movement loader 23 can occur concurrently or at different points in time.

### LIST OF REFERENCE SIGNS

10 machine tool
11 rack magazine
12 workpiece holder
13 work space
14 work spindle
15 tool holding device
15a, 15b sections of tool holding device 15
16 setup unit
17 storage space
18a first tool holder receptacle means
18b second tool holder receptacle means
19 tools
20 removal passage
21 cutouts
22 loader passage
23 loader
24 separation device
25 separation element
Ea plane of first tool holder receptacle means 18a
Eb plane of second tool holder receptacle means 18b
26 interstice
27 complement magazine
28 support bar
29 slide
30 vertical guide
31 arm
A, B axis
32, 33 pivot drive
34 gripper
35 control
36 drive device of separation element
37 sensors
38 machine control
39 tool changer
40 pivot axis of tool changer 39
41 position mark
42 tool holder
43 holding or support means

1. A tool rack magazine for a machine tool for chip removing machining of metal workpieces, comprising:
a tool holding device configured for holding tools,
at least one setup unit that can be moved into and out of a storage space in the tool holding device,
a loader that can be moved in a second direction inside a loader passage, which is orientated transverse to a first direction, wherein the loader passage extends along the tool holding device including the setup unit,
wherein a separation device is provided between the loader passage and the storage space.

2. The tool rack magazine according to claim 1, wherein the tool holding device comprises first tool holder receptacle means adapted to tool holders.

3. The tool rack magazine according to claim 1, wherein the tool holding device is configured to hold all tools in a horizontal orientation facing away from the loader passage.

4. The tool rack magazine according to claim 3, wherein the tool holding device is configured to receive and store the tools in rows arranged above one another.

5. The tool rack magazine according to claim 4, wherein removal passages are provided between the rows.

6. The tool rack magazine according to claim 2, wherein the setup unit comprises second tool holder receptacle means.

7. The tool rack magazine according to claim 6, wherein the second tool holder receptacle means are configured to store the tools in the same orientation as the first tool holder receptacle means, if the setup unit is arranged inside the storage space.

8. The tool rack magazine according to claim 6, wherein the first tool holder receptacle means are arranged in a first plane and the second tool holder receptacle means are arranged in a second plane and that wherein the first and the second plane are arranged in a distance to one another and define an interstice in this manner.

9. The tool rack magazine according to claim 8, wherein the separation device is arranged inside the interstice.

10. The tool rack magazine according to claim 9, wherein the separation device comprises a closure element that can be moved into and out of the interstice and that the closure element is configured to block a passage between the storage space and the loader passage, if it is placed inside the interstice.

11. The tool rack magazine according to claim 10, wherein the closure element is connected to a drive device that is configured to move the closure element between an open position and a closing position.

12. The tool rack magazine according to claim 11, wherein the rack magazine comprises a control that is connected with the loader and the drive device in order to control them.

13. The tool rack magazine according to claim 12, wherein the control is configured to stop the operation of the loader, if and as long as the following conditions are both fulfilled: a) the closure element is not in the closing position and b) the setup unit is not located inside the storage space.

14. The tool rack magazine according to claim 12, wherein the control is configured to enable the operation of the loader in an unlimited manner, if and as long as the following conditions are both fulfilled: a) the closure element is in the open position and b) the setup unit is located inside the storage space.

15. The tool rack magazine according to claim 12, wherein the control is configured to limit the operation of the loader for serving the first tool holder receptacle means, if and as long as the following condition is fulfilled: a) the closure element is in the closing position.

16. The tool rack magazine according to claim 1, wherein holding and support means are provided in the storage space for exact positioning of the setup unit.

17. The tool rack magazine according to claim 1, wherein at least one position mark is arranged on the setup unit.

18. The tool rack magazine according to claim 1, wherein a sensor, particularly a camera or a tactile sensor, is arranged in the storage space and/or in the loader passage and/or on the loader.

19. A machining center having a rack magazine according to claim 1.

20. The tool rack magazine according to claim 2, wherein the tool holding device is configured to hold all tools in a horizontal orientation facing away from the loader passage.
